(19) United States
(12) Patent Application Publication
(10) Pub. No.: US 2006/0167935 A1
(43) Pub. Date: Jul. 27, 2006

(54) Input support method and apparatus in communication-type navigation system

(76) Inventors: Yoshitaka Atarashi, Hitachi (JP); Mariko Okude, Hitachi (JP); Takashi Nakahara, Hitachi (JP); Shigeru Matsuo, Hitachinaka (JP); Yukihiro Kawamata, Hitachi (JP)

Correspondence Address: CROWELL & MORING LLP;INTELLECTUAL PROPERTY GROUP, P.O. BOX 14300, WASHINGTON, DC, 20044-4300, US

(21) Appl. No.: 10/525,081

(22) PCT Filed: Oct. 15, 2003
(86) PCT No.: PCT/JP03/13200

§ 371 Date: Aug. 16, 2005

(30) Foreign Application Priority Data
Oct. 15, 2002 (JP) 2002-301069
Jan. 14, 2003 (JP) 2003-006418

(51) Int. Cl. G06F 17/00

(52) U.S. Cl. 707/104.1

(57) ABSTRACT

The invention provides an input support method and apparatus having the following merits in a communication-type navigation system. That is, when at least one character relevant to, for example, a destination is inputted from a navigation apparatus to make a search in a server system, it is possible to minimize time spent in waiting for a response from the server system. Accordingly, communication time is shortened, and a pleasant environment for input operation is realized by making the most of information inputted by a user. In the input support method in a communication-type navigation system, a navigation apparatus (1) and a server system (4) are connected via a communication network (3). The input support method is comprised of the following steps: a first step of obtaining candidate characters for next input and the number of candidates pertaining to an input character string from the server system (4) via the communication network (3), and storing them into a cache memory (14) provided in the navigation apparatus (1); a second step of, at least when an input character string is updated at the navigation apparatus, searching the cache memory for candidate characters following the updated input character string and the number of candidates pertaining to the updated input character string; and a third step of, when the candidate characters following the updated input character string and the number of candidates pertaining to the updated character string have not been stored in the cache memory as yet, transmitting the updated input character string to the server system.

### TECHNICAL FIELD

The present invention relates to an input support method and apparatus in a communication-type navigation system.

### BACKGROUND ART

In the field of ITS (Intelligent Transport System), communication-type navigation systems which enable, via data communication between an on-vehicle navigation apparatus and a server system, map data and other kinds of useful information to be transmitted to the on-vehicle navigation apparatus have been introduced and drawing attention.

When inputting characters to the navigation apparatus, for example, to set a destination or search for a location, usually a touch panel which is provided for the on-vehicle navigation apparatus or for an associated remote control unit is used.

Typically, a touch panel can be input data via a soft keyboard displayed on a screen (see patent document 1). For soft keyboards, many proposals aimed at improving usability have been made. Among such proposals are : (a) when, in a search operation, a character is inputted based on the Japanese syllabary, only the characters that may, based on prepared data, follow the inputted character are displayed on a screen to make the search operation easier; and (b) every time a character is inputted in a name search operation, the displays of Japanese syllabary characters which cannot follow the inputted character are dimmed, or when only a part of a name to be searched for is known, a partial-match search is enabled to generate a list of partial matches from which the searcher can select one (see non-patent document 1).

The above prior arts, while they may facilitate a search operation or character input operation, do not consider reducing communication time and coping with a communication interruption which may be caused, for example, when a car having a navigation apparatus enters a tunnel. Solving such themes is important in communication-type navigation systems.

An object of the present invention is to provide an input support method and apparatus in a communication-type navigation system:

which, when at least one character relevant to, for example, a destination is inputted from a navigation apparatus by a user to retrieve data stored in a server system, can download candidate characters following the last inputted character from the server system so as to facilitate the subsequent input operation by the user;

which, when an erroneous key operation is made by the user while a response from the server system is being awaited or when a communication interruption occurs, can shorten the time spent in waiting for a response from the server system so as to eventually reduce the communication time; and

which can materialize a pleasant environment for input operation by making use of information inputted by the user.

### DISCLOSURE OF INVENTION

According to an input support method and apparatus in a communication-type navigation system of the present invention, when a part of a character string relevant to, for example, a destination is inputted at a navigation apparatus, a cache memory of a navigation apparatus is searched for candidate characters following the last inputted character and the number of candidates (for example, destination candidates). And, in a case in which such candidate characters and the number of candidates have not been stored in the cache memory, a request for such candidate characters and the number of candidates is issued from navigation apparatus to a server system. The candidate characters and the number of candidates, when downloaded from the server system to the navigation apparatus, are stored in the cache memory. In this way, next time the same search is made, it is not necessary to download the data from the server system.

According to an input support method and apparatus in a communication-type navigation system of the present invention, when a part of a character string relevant to, for example, a destination is inputted at a navigation apparatus, candidate characters following the last inputted character are downloaded from a server system so as to simplify the subsequent input operation. Also, when no character is inputted for a prescribed period of time or when a button for determining candidate characters for next input is pressed, a request to transmit candidate characters is issued to the server system.

Furthermore, if a character is additionally inputted by a user while a response including candidate characters for next input from the server system is being awaited, the subsequent response from the server system is invalidated. Or, a response from the server system is validated only if the character string that has been inputted when the response from the server system is received is identical with the character string last transmitted to the server system.

In this way, the time spent waiting for a response from the server system and eventually the communication time can be reduced. Furthermore, even if an error key operation is made while a response from the server system is being awaited, the preceding request issued to the server system is not wasted so that the time spent waiting for a response from the server system can be eventually reduced.

### BRIEF DESCRIPTION OF THE DRAWINGS

FIG. 1 is a block diagram showing a configuration of a communication-type navigation system according to the present invention;

FIG. 2 shows a display configuration of a touch panel used in the input support apparatus shown in FIG. 1;

FIG. 3 is a flowchart of processing for an address search performed, when ACM (Auto Connection Mode) has been set to “ON” with a communication mode switching button, using an input support method and apparatus in a communication-type navigation system according to the present invention;

FIG. 4 is a flowchart of processing for an address search performed, when ACM (Auto Connection Mode) has been set to “OFF” with a communication mode switching button, using an input support method and apparatus in a communication-type navigation system according to the present invention;

FIG. 5 shows processing for an address search performed in a communication-type navigation system according to the present invention by inputting characters “F”, “A”, and “R” one by one when communication is stable;

FIG. 6 shows processing for an address search performed in a communication-type navigation system according to the present invention by inputting characters “FAR”;

FIG. 7 shows processing in which characters “F”, “A”, and “R” are inputted one by one in a communication-type navigation system according to the present invention and in which a communication delay occurs when “A” is inputted;

FIG. 8 is a diagram for explaining processing performed, when a search request transmitted to a server system, the response from the server system is not performed in a certain period of time, in a communication-type navigation system according to the present invention;

FIG. 9 is a diagram for explaining processing which allows inputted characters to be corrected, when search results composed of candidate characters following already inputted characters “FAR” and the number of candidates (for example, destination candidates) are belatedly received by an on-vehicle terminal system in a communication-type navigation system according to the present invention;

FIG. 10 shows a POI (Point of Interest) search screen;

FIG. 11 shows an operation performed on a screen to erase data stored in a cache memory;

FIG. 12 is a diagram showing content of a cache memory;

FIG. 13 is a block diagram showing an internal configuration in terms of functions of an input support apparatus according to the present invention;

FIG. 14 is an operational sequence diagram for explaining operation of an input support apparatus according to the present invention;

FIG. 15 is an operational sequence diagram for explaining operation of an input support apparatus according to the present invention; and

FIG. 16 is an operational sequence diagram for explaining operation of an input support apparatus according to the present invention.

### BEST MODE FOR CARRYING OUT THE INVENTION

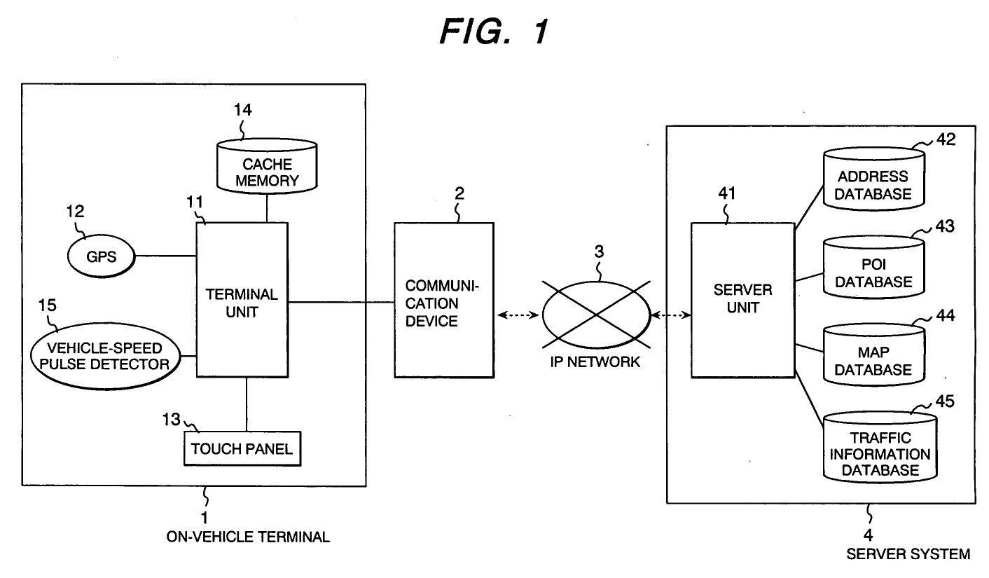

FIG. 1 is a block diagram showing a configuration of a communication-type navigation system according to the present invention.

In FIG. 1, reference numeral 1 denotes an on-vehicle terminal system 1 used as navigation apparatus. The on-vehicle terminal system includes a terminal unit 11 which incorporates a CPU. A cache memory 14 is made of a nonvolatile memory card provided in the terminal unit 11. Peripheral devices, such as a GPS (Global Positioning System) 12, an input/output device (hereinafter referred to as a touch panel) 13 for a coordinate input device attached to the front of the liquid crystal display and a vehicle-speed pulse detector 15, are connected to the terminal unit 11. The cache memory 14 may be mounted on an internal circuit board of the terminal unit 11.

The cache memory 14 holds data retrieved using a search condition as a key. The cache memory 14 has memorized inquiries transmitted to the server system until now and can make an inquiry independently of input operation being done at the terminal. It is explained in detail as follows. At first, the server system performs a search based on information inputted via the touch panel 13, the searched results are transmitted to the on-vehicle terminal, and the cache memory 14 memorizes the searched results from the server system as data. After that, when an input operation performs again at the on-vehicle terminal system 1 and the searched results to be responded to the input can be provided from data stored in the cache memory 14, the inquiry for search is not transmitted to the server system via a communication line. Therefore, when a search condition is inputted from the touch panel 13, the terminal unit 11 does not immediately transmit a corresponding inquiry to the server system 4 via a communication line. When a search condition is inputted from the touch panel 13, the terminal unit 11 first accesses the cache memory 14 to make an inquiry whether or not search results corresponding to the search condition have been stored there. When the corresponding search results have not been stored in the cache memory 14, the terminal unit 11 then transmits the inquiry of the search condition to the server system 4 via a communication line to obtain the corresponding search results.

FIG. 13 is a block diagram showing an internal configuration in terms of functions of an input support apparatus which the terminal unit 11 according to the present invention is equipped with. The input support apparatus according to the present invention is mounted in the terminal unit 11 of the on-vehicle terminal system 1 shown in FIG. 1. The input support apparatus includes, as shown in FIG. 13, an input character transmitting section 131, a response invalidation/validation control section 132, a reconnection processing section 133, a response waiting section 134, and an attribute display control section 135.

The input character transmitting section 131 has a function to transmit the input character string to the server system 4 under the following conditions, that is when at least one character is inputted by a user from the touch panel 13 and a next candidate character find button (Find) is not operated or the contents of the input character string which is a string of inputted characters have not been changed every time they are periodically checked.

Although candidate characters following the input character string are received as a response from the server system 4, the response invalidation/validation control section 132 has a function to invalidate the response when there is an input of additional character(s) while waiting for the response from the server system 4. The response invalidation/validation control section 132 also has a function to validate the response from the server system only when the input character string at the time of the response from the server system 4 is identical with the character string last transmitted to the server system 4.

The reconnection processing section 133 and the response waiting section 134 are provided to cope with an interruption of the communication. If the communication is interrupted while waiting for the response of candidate characters following the input character string to come from the server system 4, the reconnection processing section 133 detects the communication interruption and makes a recovery of the communication again.

The response waiting section 134 also has a function to wait for the response from the server system 4 to the last transmitted inquiry under only the following condition when an additional character is input while recovering the communication by the reconnection processing section 133. The condition is that the input character string is identical with the character string last transmitted to the server system 4. When candidate characters following the last (updated) input character of the string are received as a response from the server system 4, the attribute display control section 135 has a function to select the keys corresponding to the candidate characters from a key board, and to indicate differently from other keys on the keyboard displayed on the screen, for example, by changing the color of the keys or by blinking or otherwise highlighting the keys.

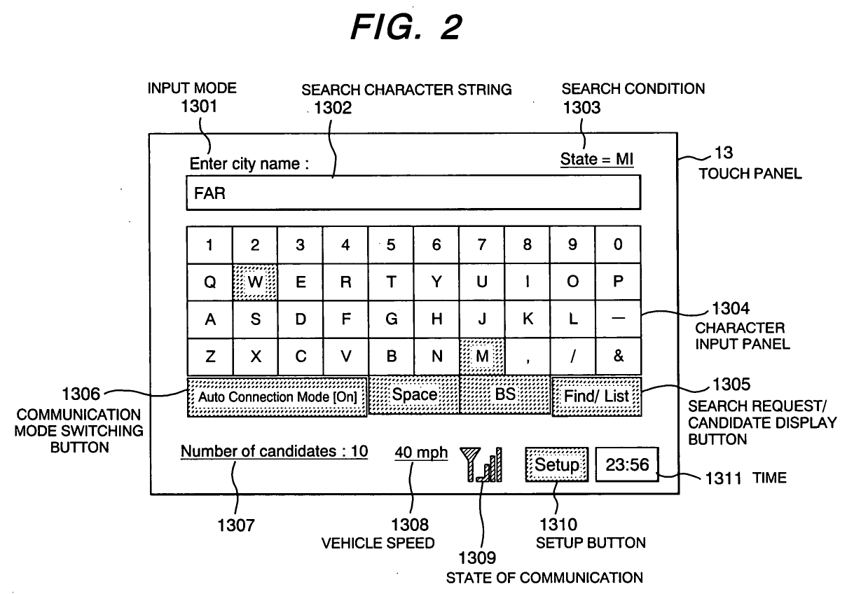

When making a search based on an address or a place name, a display as shown in FIG. 2 appears on the touch panel 13. As shown in FIG. 2, the display includes an input mode display area 1301 for indicating an area category (for example, state, county, or city) for input to be made, a display area 1302 for search character string used in making an address search, a display area 1303 for displaying a search condition 1303, a display area 1304 for a character input panel which is a display of a keyboard and which is used to input a character string (for example, representing a city name to be searched for), a display area 1305 for a search request/candidate display button which is used to issue an instruction to transmit the character string inputted by pressing on the character input panel 1304 to the server system to search for candidate addresses based on the input character string, a display area 1306 for a communication mode switching button which concerns connection to the server system, a display area 1307 for indicating the number of candidates extracted at the server system in response to a search request transmitted to the server system, a display area 1308 for indicating a current vehicle speed, a display area 1309 for a current state of communication which informs the state of a communication device 2a through indicating a radio field intensity and other information using, for example, an icon and a moving image, a display area 1310 for a setup button, and a display area 1311 for indicating a time.

When a part of a character string relevant to, for example, a destination is inputted at the on-vehicle terminal system 1, candidate characters following the input character string are downloaded from the server system 4 and the keys representing the candidate characters are highlighted on the character input panel 1304. In the example shown in FIG. 2, characters “W” and “M”, “Space” which is a space character used as a delimiter, and “BS” which is used for backspacing to correct an input error are highlighted as candidates for the next input to follow the already inputted character string “FAR”. At that moment, since it is possible to switch the communication mode or to request a list of candidate names, the “Auto Correction Model [On]” button and “Find/List” button corresponding to their input are also highlighted on the display.

Reference numeral 2 in FIG. 1 denotes a communication device. It is connected to the terminal unit 11 by short-range radio communication using, for example, Bluetooth(R) or infrared technology. A cable may also be used to interconnect the terminal unit 11 and the communication device 2. The communication device 2 may be, for example, a mobile phone. It is connected to an IP (Internet Protocol) network 3 via a radio base station, not shown. The on-vehicle terminal system 1 communicates with the server system 4 via the IP network 3 using the communication device 2.

The server system 4 has a server unit 41. The server unit 41 is connected to an address database 42, a POI (Point of Interest) database 43, a map database 44, and a traffic information database 45.

The address database 42 is a database storing addresses (country, state, prefecture, county, city, town) and names of cities in an area (for example, country or state) where the communication-type navigation system is used and also storing a list of candidate city names to be extracted according to input search items. The address database 42 has a function to check the date and time when the database was updated last. When transmitting data extracted from the address database 42, the address database 42 can also transmit data indicating when the data stored in the address database 42 was updated last. The data confirming the date and time of last update of the database 42 is used in determining when to update the data (when to once erase the whole data) stored in the cache memory 14 connected to the terminal unit 11 of the on-vehicle terminal system 1.

The address database 42 also has a function to narrow down candidate characters following the last inputted character of the character string based on the data stored in the database. This function will be described more concretely later.

The POI (Point of Interest) database 43 is a database storing data to be objects of searching, for example, data on locations and facilities such as restaurants, parking lots, gas stations, and so on in an area (for example, country or state) where the communication-type navigation system is used. Like the address database 42, the POI database 43 also has a function to narrow down candidate characters following the last inputted character.

The map database 44 is a database storing a general map and a road map of the whole of an area (for example, country or state) where the communication-type navigation system is used, and also storing detailed local road maps for the area.

The traffic information database 45 is a database storing traffic information, for example, information on locations entirely or partly closed to traffic, for example, due to construction work or an accident and information on locations where traffic is heavily congested, for example, due to an event being held in the vicinity.

The server system 4, in addition to transmitting map information, supports users in input operation. For example, when a user, wishing to set a destination or search for location information in order to use route guidance, inputs a part of a relevant character string like a region name and a facility name, the server system 4 extracts candidate characters for the user to input next by, for example, making a search for leading-part matches or a fuzzy search based on the characters inputted by the user.

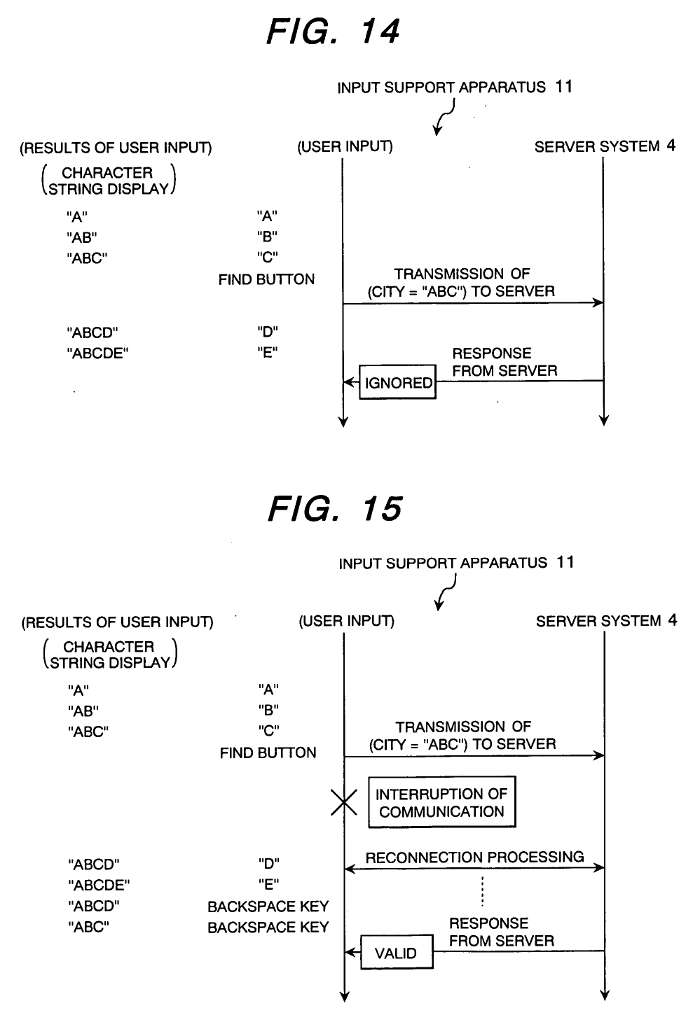

With reference to FIGS. 14, 15, and 16, processing performed between the terminal unit 11 and the server system 4 will be outlined. When a city name is being inputted, the terminal unit 11 remains ready to accept input from the touch panel 13. In the present example, assume that a string of “A”, “B”, and “C” has been inputted.

Referring to FIG. 14, when at least one character is inputted, the input support apparatus 11 transmits the character string comprised of inputted characters until now (CITY=“ABC”) to the server system 4 via the input character transmitting section 131 under the following conditions. The conditions are a case that a Find button operation is operated to determine candidate characters for the next input, or a case that no additional character has been inputted since when the last check was made to the input character string periodically. This processing by the input support apparatus 11 causes the server system 4 to search for candidate characters following the input character string. If an additional input is made (in the present example, “D” and “E” are inputted) before candidate characters following the preceding input character string (CITY=“ABC”) is received as a response from the server system 4 (namely while waiting for the response from the server system 4), the response invalidation/validation control section 132 invalidates the subsequent response from the server system 4.

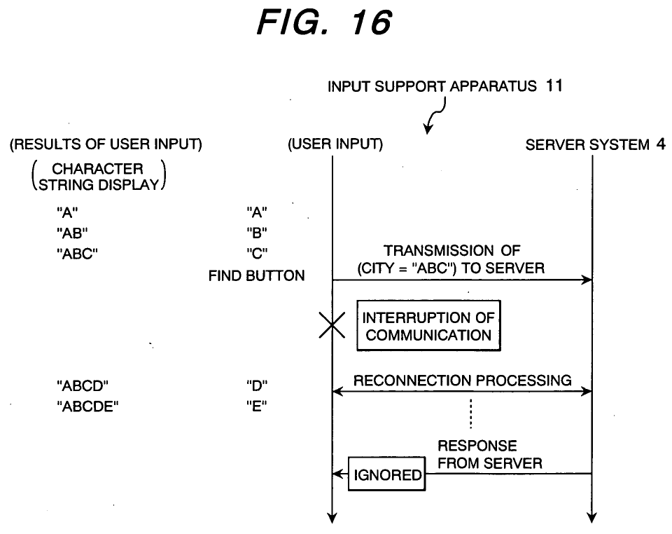

If communication is interrupted while waiting for the response from the server system 4 concerning candidate characters following the last inputted character of the character string, the reconnection processing section 133 detects interruption of the communication and reconnect the communication again. If an additional input is made before reconnection of the communication is completed, the processing that follows differs depending on the case as shown in FIGS. 15 and 16. First referring to FIG. 15, when the character string that has been last inputted is identical with the preceding character string transmitted to the server system 4 (“ABC”=“ABC”), the response waiting section 134 waits for a response from the server system 4 to treat the response as valid data.

Next referring to FIG. 16, when the character string that has been last inputted is not identical with the preceding character string transmitted to the server system 4 (“ABC”≠“ABCDE”), processing proceeds to invalidate the response received from the server system 4 to the on-vehicle system 1. When candidate characters for next are provided by the response from the server system 4, the keys representing the candidate characters are displayed differently from other keys on the keyboard showing on the touch panel 13 (LCD) of the on-vehicle terminal system 1. Namely, the keys representing the candidate characters for next are highlighted, for example, by changing their color or by flashing their display. This arrangement facilitates selection by the user of the next character to input.

As shown in FIG. 16, even in a case in which no communication interruption occurs, if a user inputs additional characters (“D” and “E”) while waiting for the response from the server system 4, the processing performed following receipt of the response from the server system 4 differs depending on whether or not the character string that has been last inputted and the preceding character string transmitted to the server system 4 are identical. When they are identical, the validation part of the response invalidation/validation control section 132 validates the response. When they are not identical, the invalidation part of the response invalidation/validation control section 132 invalidates the response.

It is possible that the on-vehicle terminal system 1 stores combinations of respective character strings inputted by a user and the candidate characters for next from the server system 14 as shown in FIGS. 14 to 16 as history information. The history information can be used for supporting character input operations after this.

To be more concrete, when a character string is inputted by a user, the on-vehicle terminal system 1 searches the history information using the input character string as a key. If the same character string is found in the history information, the corresponding candidate characters for next included in the history information are provided to the user. If the same character string is not found in the history information, the input character string is transmitted to the server system 4 to search the candidate characters in the server system 4.

In this way, when a character string inputted by the user exists in the history information, the input character string need not be transmitted to the server system 4 so that the communication time taken to a response to an inquiry can be reduced. Furthermore, candidate characters for next can be got in response to a inquiry even when communication between the on-vehicle terminal system 1 and the server system 4 is temporarily interrupted.

As described above, the present invention makes it possible, when at least one character relevant to, for example, a destination is inputted from a navigation apparatus, to download candidate characters for next from a server system to facilitate the subsequent input operation by the user. And, when an erroneous key operation is made while a response from the server system is being awaited, or when communication between the navigation apparatus and the server system is interrupted, it is possible to reduce the time spent in waiting for a response from the server system, eventually reducing the communication time.

In the case of processing in which advance searching is performed but in which automatic correction of the input character string is not performed, if the user corrects “N” following the already inputted nine characters “FARMINGTO”, candidate characters for next “H” and “O” are additionally received as a response from the server system 4. In this case, there are two candidate characters for next. The on-vehicle terminal system 1 keeps the keys locked until the key corresponding to the candidate characters “H” or “O” is inputted.

Since the on-vehicle terminal system 1 does not automatically correct the input character string, the user can continue the input operation without being confused.

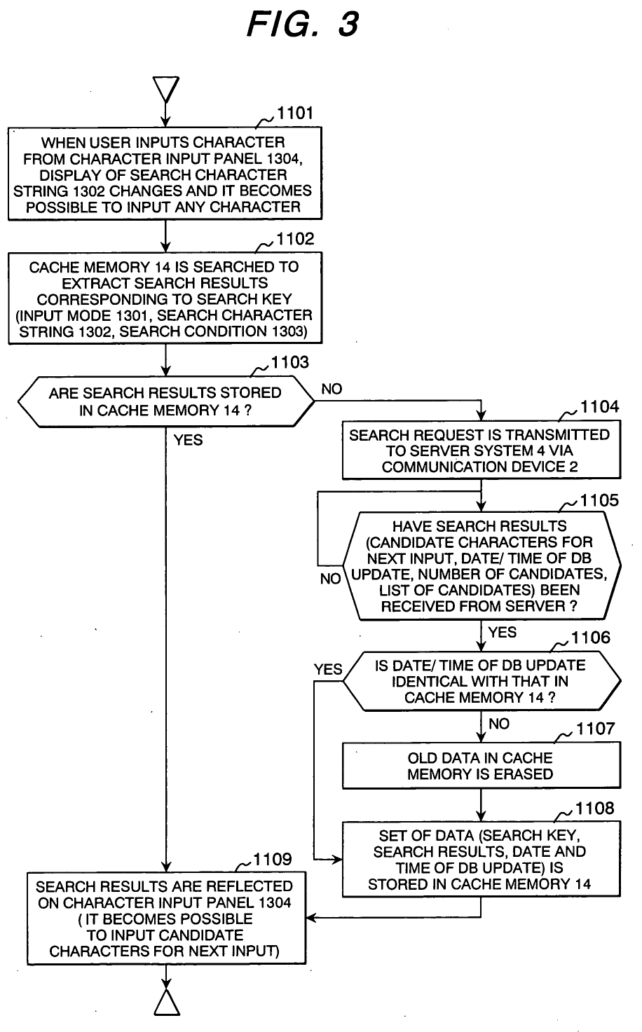

FIG. 3 is a flowchart of processing for an address search performed, when ACM (Auto Connection Mode) has been set on with the communication mode switching button 1306, using an input support method and apparatus in a communication-type navigation system according to the present invention. In the communication-type navigation system according to the present invention, when a user searching for a location using a place name or a city name inputs characters from the touch panel 13, the inputted characters are transmitted to the server system 4 via the communication device 2. The server system 4 performs a search based on the received characters and transmits a response including the results of the search to the on-vehicle terminal system. In the on-vehicle terminal system 1, the search results from the server system 4 are stored in the cache memory 14 made of a storage device such as a nonvolatile memory device thereby making the search results reusable in the future. The search results stored in the cache memory 14 are referred to when a location search is made thereafter.

In a state in which ACM is on, every time a character is inputted at the on-vehicle terminal system 1 to make a search operation, the inputted character is transmitted to the server system 4. In a state in which ACM is off, characters inputted at the on-vehicle terminal system 1 to make a search operation are temporarily held in the on-vehicle terminal system 1. The characters are transmitted to the server system 4 when the search request/candidate display button 1305 is pressed.

Referring to FIG. 3, before an address search is started, the character input panel 1304 waits for the first character to be inputted by a user. At this time, all the key/button areas of the character input panel 1304 are highlighted indicating that any character may be inputted. In step 1101, when the user inputs a character from the character input panel 1304 on the touch panel 13, the display of the search character string 1302 changes correspondingly and the inputted character is echoed back making the character input panel 1304 ready to accept any character input. This is, as will be described in detail later, to enable the user to input search characters in advance even if communication between the server system 4 and the on-vehicle terminal system 1 is interrupted. After the character input panel 1304 becomes ready to accept any character input in step 1101, search results corresponding to the search key composed of the input mode 1301, the search character string 1302 and the search condition 1303 shown in FIG. 2 are extracted from the cache memory 14 in step 1102. In the example shown in FIG. 2, the input mode is “Enter city name”, the search character string is “FAR”, and the search condition is “State=MI”. It indicates that the search key used in this example searches for a city which is in the State of Michigan and whose name begins with “FAR”. In step 1103, whether or not search results corresponding to the search key have been stored in the cache memory 14 is determined. When it is determined in step 1103 that no search results corresponding to the search key have been stored in the cache memory 14, a search request is transmitted to the server system 4 via the communication device 2 in step 1104.

After the search request is transmitted to the server system 4 in step 1104, it is determined in step 1105 whether or not search results (including candidate characters for next, date and time of last database update, number of candidates, and a list of candidates) have been received as a response from the server system 4 to the on-vehicle Namely, this step 1105 is used to wait for a response from the server system 4. When it is determined in step 1105 that the search results have been responded from the server system 4, processing advances to step 1106. In step 1106, it is determined whether or not the date and time of last database update included in the search results from the server system 4 in step 1105 is identical with the corresponding date and time stored in the cache memory 14. The processing to be performed when there is no response from the server system 4 in a certain period of time will be described later.

The date and time of last database update indicates when the address database for the area corresponding to the search condition included in the search key transmitted from the on-vehicle terminal system 1 was last updated. The number of candidates indicates the number of cities narrowed down based on the search character string in the area corresponding to the search condition. The list of candidates indicates the names of cities narrowed down in the same way. The candidate characters for next are characters following the respective searched candidate strings which have been extracted from the list of candidates. Namely respective the candidate characters for next input are added to current candidate character strings in input mode.

If it is determined in step 1106 that the date and time of last database update included in the search results from the server system 4 is newer than the corresponding date and time stored in the cache memory 14, the old data stored in the cache memory 14 is erased. An arrangement may be made to erase, out of the whole data stored in the cache memory 14, only the data corresponding to the input mode 1301 and the search condition 1303 included in the search key so as to leave as much data as possible in the cache memory 14. A different arrangement may be made so as to erase, out of the data corresponding to the input mode 1301 and the search condition 1303, only the data items beginning with the search character string. If it is determined in step 1106 that the date and time of last database update included in the search results from the server system 4 is identical with the corresponding date and time stored in the cache memory 14, the search key, the search results, and the date and time of last database update are mutually associated and stored in the cache memory 14 in step 1108. Processing then advances to step 1109. The search results to be stored in the cache memory 14 include at least the candidate characters for next input and the number of candidates included in the search results from the server system 41.

Processing advances to step 1109 also when it is determined in step 1103 that search results corresponding to the search key have been stored in the cache memory 14. In step 1109, based on the search results retrieved from the cache memory 14 or responded from the server system 41, the areas corresponding to the candidate characters for next input of the character input panel 1304 are highlighted, and then enabling the candidate characters as well as “BS” to be inputted.

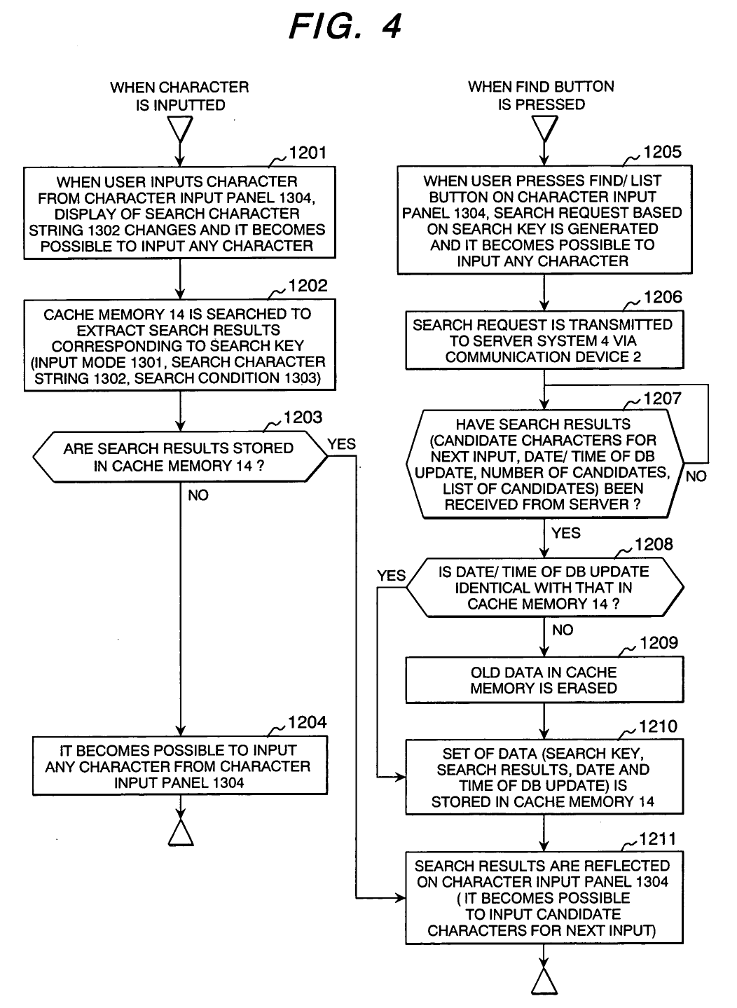

FIG. 4 is a flowchart of processing for an address search performed by the input support method and apparatus in a communication-type navigation system according to the present invention under the following conditions, that is when ACM (Auto Connection Mode) has been set to OFF with the communication mode switching button 1306. When ACM (Auto Connection Mode) is OFF, inputting of a search character string and transmission of a search request to the server system are performed asynchronously so that the flowchart is broadly divided into two parts. The basic processing performed is however similar to the processing shown in the flowchart of FIG. 3.

Referring to FIG. 4, as in the case shown in the flowchart of FIG. 3, before an address search is started, the character input panel 1304 waits for the first character to be inputted by a user. At this time, all the areas of the character input panel 1304 are highlighted indicating that any character may be inputted. In step 1201, when the user inputs a character from the character input panel 1304 on the touch panel 13, the inputted character is echoed back to the search character string 1302. Then the search character string is updated and the character input panel 1304 becomes ready to accept any character input. Next in step 1202, as in step 1102 shown in FIG. 3, search results corresponding to the search key (composed of the input mode 1301, the search character string 1302 and the search condition 1303 shown in FIG. 2) are extracted from the cache memory 14.

In step 1203, whether or not the search results obtained in the past have been stored in the cache memory 14 is determined. When it is determined in step 1203 that the search results obtained in the past have been stored in the cache memory 14, processing advances to step 1211.

If it is determined in step 1203 that the search results obtained in the past have not been stored in the cache memory 14, processing advances to step 1204. In step 1204, the character input panel 1304 shown in FIG. 2 is entirely highlighted to indicate that any character may be inputted. In this way, during a search character string input operation, the character input panel 1304 is kept ready to accept any character input. The characters inputted by a user appear in the display of the search character string 1302 and they are temporarily held in memory without being transmitted to the server system until the search request/candidate display button 1305 is pressed.

When the search request/candidate display button 1305 is pressed under the state where the search character string including at least one character has been inputted, processing from step 1205 is starts. In step 1205, when the user presses the search request/candidate display button 1305, i.e. the “Find/List” button, after inputting at least one character from the character input panel 1304, a search request is generated based on a search key (composed of the input mode 1301, the search character string 1302, and the search condition 1303 shown in FIG. 2) and the character input panel 1304 becomes ready to accept any character input. Thus, as will be described later, the user is enabled to input more search characters without waiting for a response from the server system 4. Next in step 1206, the generated search request is transmitted to the server system 4 via the communication device 2.

After the search request is transmitted to the server system 4, it is determined in step 1207 whether or not search results (including candidate characters for next input, date and time of last database update, number of candidates, and a list of candidates) have been received as a response from the server system 4 shown in FIG. 1. Namely, this step 1207 is used to wait for a response from the server system 4. When it is determined in step 1207 that the search results have been received as a response from the server system 4, processing advances to step 1208. In step 1208, it is determined whether or not the date and time of last database update, which is included in the search results from the server system 4 in step 1207, is identical with the corresponding date and time stored in the cache memory 14. The search results to be stored in the cache memory 14 include, as described in the foregoing, at least the candidate characters for next input and the number of candidates included in the search results from the server system 41.

If it is determined in step 1208 that the date and time of last database update included in the search results from the server system 4 is not identical with the corresponding date and time stored in the cache memory 14, the old data stored in the cache memory 14 is erased in step 1209 as in step 1107 shown in FIG. 3. If it is determined in step 1208 that the date and time of last database update included in the search results from the server system 4 is identical with the corresponding date and time stored in the cache memory 14, the search key, the search results, and the date and time of last database update are mutually associated and stored in the cache memory 14 in step 1210.

If the data stored in the cache memory 14 is updated in step 1210, or if it is determined in step 1203 that search results obtained in the past have been stored in the cache memory 14, processing advances to step 1211. In step 1211, the areas corresponding to the candidate characters for next input of the character input panel 1304 are highlighted enabling the candidate characters as well as “BS” to be inputted based on the search results retrieved from the cache memory 14 or received from the server system 41.

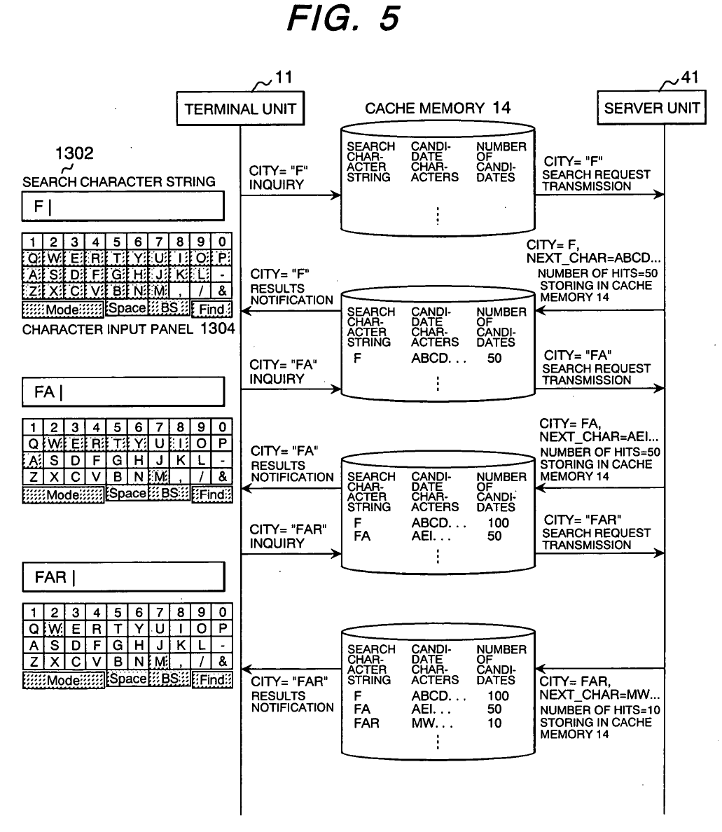

Next, with reference to FIGS. 5 to 9, processing for an address search will be concretely described taking an example of inputting a city name (CITY) as a destination.

FIG. 5 shows processing for an address search made by inputting characters “F”, “A”, and “R” one by one in a state in which ACM (Auto Connection Mode) is on and communication is stable.

For a city name input operation, the terminal unit 11 of the on-vehicle terminal system 1 is on ready to accept character input from the touch panel 13. In the present example, characters “F”, “A”, and “R” are successively inputted.

When a user inputs the first character “F” to the character input panel 1304 shown in FIG. 2, the “F” appears as the search character string 1302 shown in FIG. 2 by updating of the character string. The terminal unit 11 of the on-vehicle terminal system 1 then extracts search results corresponding to the search key (composed of the input mode 1301, the search character string 1302, and the search condition 1303 shown in FIG. 2) from the cache memory 14. In other words, the terminal unit 11 of the on-vehicle terminal system 1 checks whether or not search results corresponding to the search character “F” displayed as the search character string 1302 and the input mode of city name (CITY) have been stored in the cache memory 14. At first, since no past search results have been stored in the cache memory 14, so the terminal unit 11 transmits a request to make a search based on the search character “F” to the server unit 41 via the communication device 2. In FIG. 5, “CITY=“F”” represents a search key, that is, a city name beginning with the search character “F”. After making the requested search, the server unit 41 transmits search results “CITY=F, NEXT_CHAR=ABCD . . . , number of hits=100” to the terminal unit 11. In the following description, both textual and graphical, of the date and time of last database update will be omitted. Here, “CITY=F” means that city names each of which begins with “F” were searched for, “NEXT_CHAR=ABCD . . . ” means that the candidate characters for next input are “ABCD . . . , and “number of hits=100” means that there are 100 candidates as the city to be searched. The search results are stored in the cache memory 14 for the present. Accordingly, the candidate characters (A, B, C, . . . ) following the “F” of the search character string in the city name and the number (100) of candidates are obtained as the search results of the search key CITY=“F”. The search results are reflected on the character input panel 1304 shown in FIG. 2, thereby making it possible to input one of the candidate characters. Namely, at the character input panel 1304 used to input a search character string (for example, a city name), it becomes possible to input the candidate characters (A, B, C, . . . ) following the “F” and “BS” used to correct the input character string. The character input panel 1304 locks the keys corresponding to the other characters so as to prevent an erroneous input. In the following, the search condition 1303 that is regarded as being fixed in the present example will not be explained. Note, however, that the search condition 1303 is used as a part of the search key when judgment of search key matching is made in searching the cache memory 14 or when a name search is made in the server apparatus 4.

When candidate characters (for example, A, B, C, . . . ) following the “F” displayed as the search character string 1302 and the number of candidates (for example, 100) are extracted by the terminal unit 11 of the on-vehicle terminal system 1 and the search results are reflected on the character input panel 1304 making it possible to input the candidate characters, the user inputs “A” out of the candidate characters to the character input panel 1304.

When the user inputs the character “A” from the character input panel 1304, the display of search character string 1302 becomes to “FA” as updated string. Also when the user inputs the character “A” from the character input panel 1304, the terminal unit 11 of the on-vehicle terminal system 1 extracts past search results corresponding to the search key composed of the input mode 1301, the search character string 1302, and the search condition 1303 from the cache memory 14. When past search results corresponding to the search key have been already stored in the cache memory 14, the terminal unit 11 extracts candidate characters (for example, A, E, I, . . . ) following the “FA” and the number of candidates (for example, 50) and reflects the extracted search results on the character input panel 1304. It then becomes possible to input the candidate characters (A, E, I, . . . ) following the “FA” through the character input panel 1304 used to input a search character string (for example, a city name). On the character input panel 1304, the keys corresponding to the other characters are locked.

If past search results corresponding to the search key have not been stored in the cache memory 14, the search request is transmitted from the terminal unit 11 of the on-vehicle terminal system 1 to the server unit 41 of the server system 4 via the communication device 2.

When the search results (candidate characters A, E, I, . . . for next input and the number of candidates 50) obtained by a search performed in the server system 4 in response to the search request are received by the terminal unit 11 of the on-vehicle terminal system 1, they are reflected on the character input panel 1304 and stored in the cache memory 14.

After extracting the candidate characters (A, E, I, . . . ) following the “FA” displayed as the search character string 1302 and the number of candidates (50), and reflecting the search results on the character input panel 1304 making it possible to input the candidate characters, the terminal unit 11 waits for an input to be made by the user.

When the user inputs character “R” from the character input panel 1304, the display of the search character string 1302 changes to “FAR”. Also when the user inputs the character “R” from the character input panel 1304, the terminal unit 11 extracts, as described above, past search results corresponding to the search key composed of the input mode 1301, the search character string 1302, and the search condition 1303 from the cache memory 14. When past search results corresponding to the search key have been already stored in the cache memory 14, the terminal unit 11 extracts candidate characters (for example, M, W, . . . ) following the “FAR” displayed as the search character string 1302 and the number of candidates (for example, 10) and reflects the extracted search results on the character input panel 1304. It then becomes possible to input the candidate characters (M, W, . . . ) following the “FAR” through the character input panel 1304. On the character input panel 1304, the keys corresponding to the other characters are locked.

If past search results corresponding to the search key have not been stored in the cache memory 14 shown in FIG. 1, a search request is transmitted from the terminal unit 11 to the server unit 41 via the communication device 2.

When the search results (candidate characters M, W, . . . for next input and the number of candidates 10) obtained by a search performed in the server system 4 in response to the search request are received by the terminal unit 11 of the on-vehicle terminal system 1, they are reflected on the character input panel 1304 and stored in the cache memory 14 shown in FIG. 1.

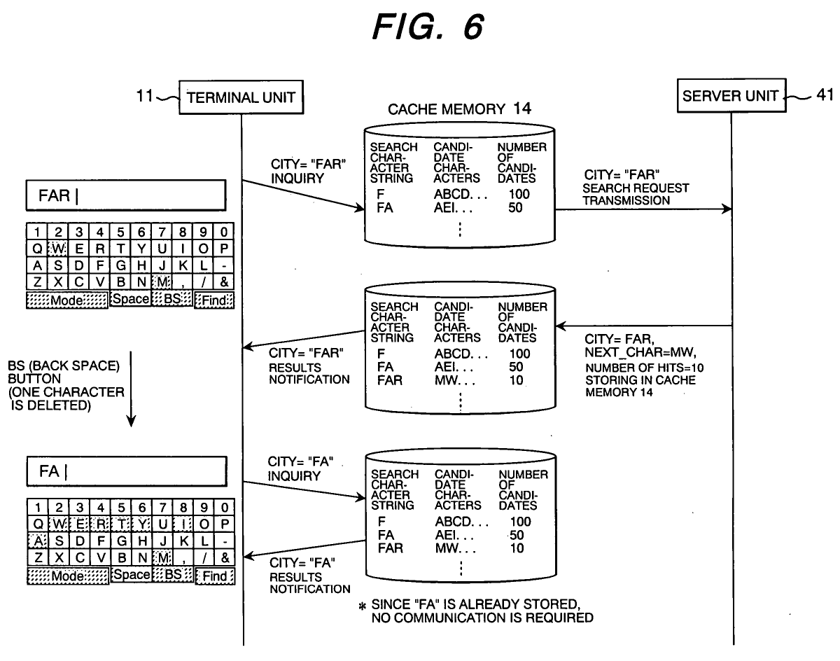

Next, processing performed when the “BS” (backspace) button is pressed after characters “FAR” have been inputted will be described with reference to FIG. 6.

FIG. 6 shows processing for an address search made by inputting characters “FAR”. When a user inputs the characters “FAR” to the character input panel 1304, the display of the search character string 1302 changes to “FAR”. The terminal unit 11 then extracts search results corresponding to the search key composed of the input mode 1301, the search character string 1302, and the search condition 1303 from the cache memory 14. By making an inquiry with the search characters “FAR”, the terminal unit 11 learns that, whereas character strings “F” and “FA” based on past search results obtained by inquiring the server unit 4 have been stored in the cache memory 14, but the character string “FAR” have been not stored. To obtain candidate characters following the “FAR”and the number of candidates, the terminal unit 11 transmits a request to make a search using the search character string “FAR” to the server unit 41 via the communication device 2. When search results (for example, candidate characters M, W, . . . to be inputted next and the number of candidates 10) obtained by a search performed in the server system 4 in response to the search request are received by the terminal unit 11, they are reflected on the character input panel 1304 and stored in the cache memory 14.

Subsequently, when the “BS” button shown in FIG. 2 is pressed, the “R” out of the “FAR” in the search character string 1302 is erased and the display of the search character string 1302 changes to “FA”. When the display of the search character string 1302 changes to the updated string, the terminal unit 11 inquires the cache memory 14 for past search results corresponding to the search key. In the present case, the following search results obtained by inquiring the server system 4 have been already stored in the cache memory 14: “candidate characters (A, B, C, . . . ) following “F” and the number of candidates (100)”, “candidate characters (A, E, I, . . . ) following “FA” and the number of candidates (50)”, and “candidate characters (M, W, . . . ) following “FAR” and the number of candidates (10)”. Therefore, the terminal unit 11 obtains the existing search results “candidate characters (A, E, I, . . . ) following “FA” and the number of candidates (50)” in response to the inquiry made with the search characters “FA” and reflects the search results on the character input panel 1304.

As described above, providing the cache memory 14 in the on-vehicle terminal system 1 makes it possible to obtain search results without transmitting an inquiry to the server unit 41 of the server system 4 every time the search character string is changed (updated). As a result, the number of times of communication made between the terminal unit 11 and the cache memory 14 can be reduced. Furthermore, when search results corresponding to an inquiry have been already stored in the cache memory 14, the search results can be reflected on the character input panel 1304 more quickly than when it is necessary to transmit a inquiry to the server unit 4. Thereby, the irritation or frustration felt by the user waiting for search results can be reduced.

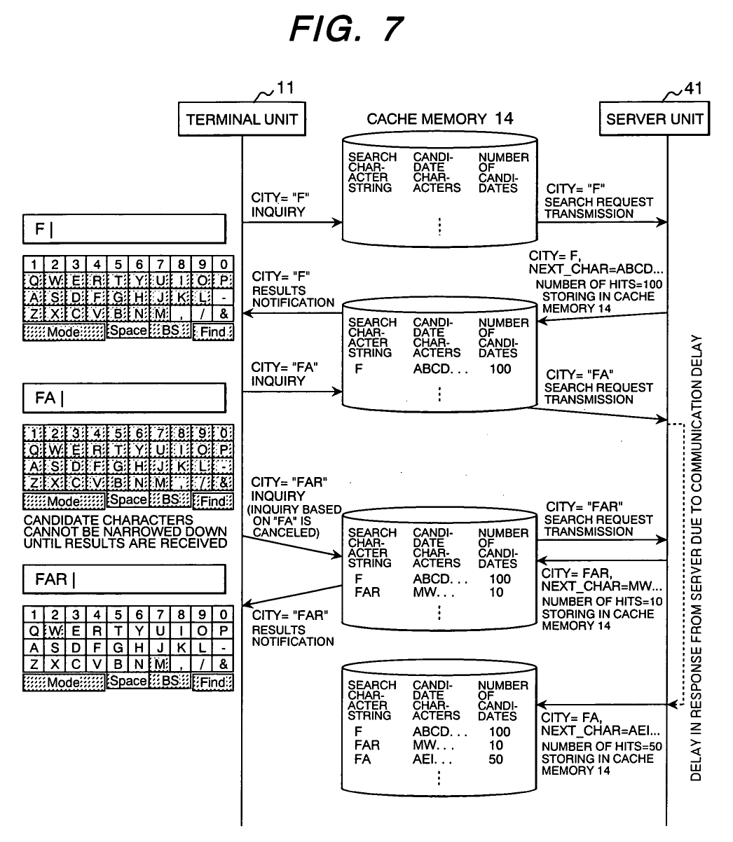

FIG. 7 shows processing in which characters “F”, “A”, and “R” are inputted one by one and in which a communication delay occurs when “A” is inputted. Whereas the processing is basically the same as the processing shown in FIG. 5, the communication delay causes some differences in the way search results are stored in the cache memory 14 and also in the way the search results are reflected on the character input panel 1304.

The processing up to when the user inputs the character “A” to the character input panel 1304 is the same as described with reference to FIG. 5 so that it will not be described in the following.

When the user inputs the character “A” to the character input panel 1304, the display of the search character string 1302 changes to “FA”. Inputting of the character “A” to the character input panel 1304 causes the terminal unit 11 to inquiry the cache memory 14 to extract candidate characters following the “FA” and the number of candidates. When search results corresponding to the inquiry have not been stored in the cache memory 14, the terminal unit 11 transmits a search request to the server unit 41 via the communication device 2.

After the character “A” was inputted and the display of the search character string 1302 changes to “FA”, the character input panel 1304 is ready to accept any character input until search results are received as a response from the server unit 41. It is therefore possible that the user inputs another character to the character input panel 1304, for example, when arrival of search results from the server unit 41 is delayed. In the present example, when character “R” is additionally inputted, the terminal unit 11 changes the display of the search character string 1302 to “FAR”. Inputting of the additional character to the character input panel 1304 causes the terminal unit 11 1 to inquiry in the cache memory 14 to extract candidate characters following the “FAR” and the number of candidates. When search results corresponding to the inquiry have not been stored in the cache memory 14, the terminal unit 11 transmits a search request to the server unit 41 via the communication device 2 without waiting for a response of the server system 4 (the server unit 41) to the preceding search request.

When the search request based on the search character string “FAR” is transmitted to the server unit 41 from the terminal unit 11 via the communication device 2, there is a case that arrival of search results from the server unit 41 responding to the preceding search request is delayed for some reason. Accordingly, there is also a case that search results for the “FAR” are received as a response from the server unit 41 at the terminal unit 11 before search results responding the preceding search request “FA” are received as a response from the server unit 41. In such a case, first, the search results for “FAR” composed of candidate characters (M, W, . . . ) following the “FAR” and the number of candidates (10) are stored in the cache memory 14 and reflected on the character input panel 1304. After that, the search results for “FA” composed of candidate characters (A, E, I, . . . ) and the number of candidates (50) are stored in the cache memory 14 without being reflected on the character input panel 1304.

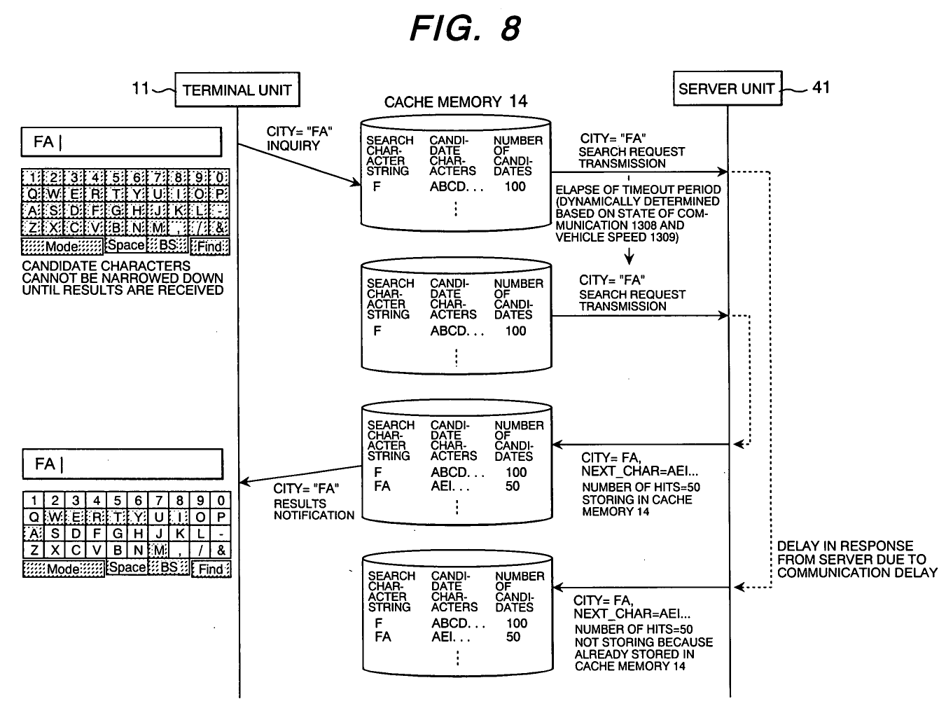

The search request to the inputted character is transmitted from the terminal unit 11 to the server unit 41 via the communication device 2, and when the response corresponding to the search request is not responded from the server unit to the terminal unit 1 in a certain period of time, the search request resend. The processing for resending will be described with reference to FIG. 8.

When the user inputs characters “FA” to the character input panel 1304, the terminal unit 11 displays the “FA” as the search character string 1302 and then inquires the cache memory 14 to extract search results corresponding to the search key. At this time, even if candidate characters (A, B, C, . . . ) following “F” and the number of candidates (100) have been stored in the cache memory 14, unless search results composed of candidate characters following the “FA” displayed as the search character string 1302 and the number of candidates have been stored in the cache memory 14, the terminal unit 11 transmits a search request to extract candidate characters following the “FA” and the number of candidates to the server unit 41 via the communication device 2.

After transmitting the search request to extract candidate characters following the search character string “FA” and the number of candidates to the server unit 41, if there is no response from the server unit 41 in a certain period of time (timeout period) on account of a communication delay, the terminal unit 11 transmits again via the communication device 2 concerning search request to extract candidate characters following the search character string “FA” and the number of candidates to the server unit 41. The timeout period is dynamically determined based on such conditions as the state of communication 1308 and the vehicle speed 1308. For example, when the vehicle speed is high or the radio field intensity is low, the timeout period is lengthened.

Subsequently, when the terminal unit 11 receives the search results (composed of candidate characters (A, E, I, . . . ) for next input and the number of candidates (50)) from the server unit 41 in response to the last search request transmitted to the server unit 41 before the timeout period for the last search request elapses, the received search results are reflected on the character input panel 1304 and stored in the cache memory 14. As a result, it becomes possible to input the candidate characters (A, E, I, . . . ) following the “FA” to the character input panel 1304 (used to enter city name), whereas, on the character input panel 1304, the keys corresponding to the other characters are locked.

If, after receiving the search results (composed of candidate characters (A, E, I, . . . ) for next input and the number of candidates (50)) from the server unit 41 in response to the last (second) search request transmitted to the server unit 41, the terminal unit 11 receives the same search results as the above-mentioned search results in response to the previous (first) search request transmitted with the same search character string “FA” to the server unit 41, the last-received search results are discarded since the same search results have been already stored in the cache memory 14.

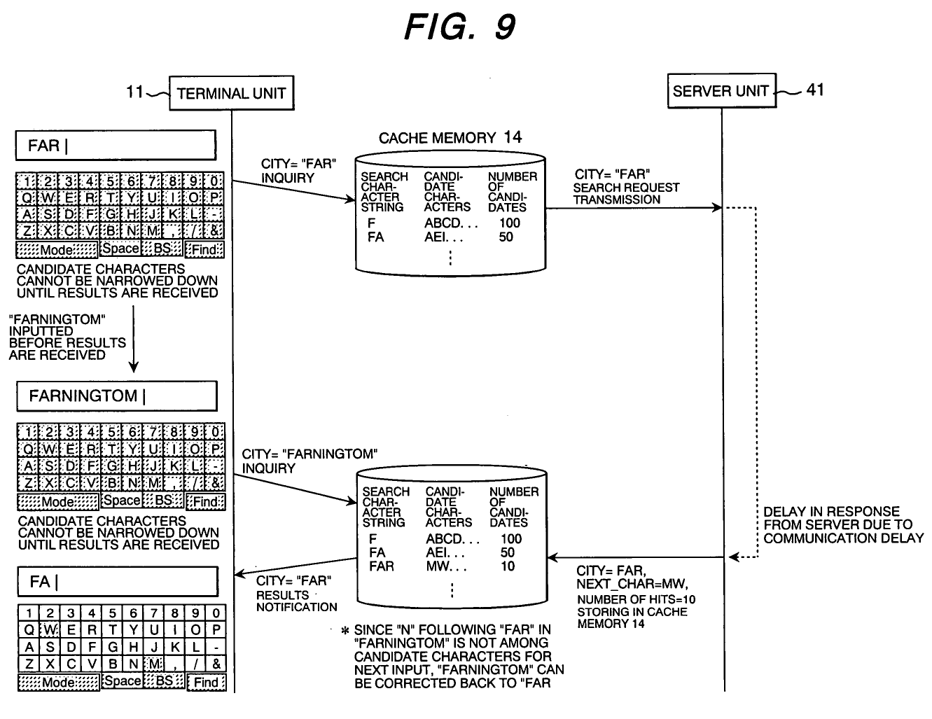

Next, processing in which inputted characters can be corrected when the terminal unit 11 belatedly receives search results composed of candidate characters following already inputted characters “FAR” and the number of candidates from the server unit 41 will be described with reference to FIG. 9.

In the present example, after a user inputs characters “FAR” from the character input panel 1304 and the inputted characters “FAR” are displayed as the search character string 1302, the terminal unit 11 inquires the cache memory 14 to extract search results corresponding to the search key. At this time, even if past search results such as the candidate characters (A, B, C, . . . ) following “F” and the number of candidates (100) and the candidate characters (A, E, I, . . . ) following “FA” and the number of candidates (50) have been stored in the cache memory 14, unless search results composed of candidate characters following the “FAR” and the number of candidates have been stored in the cache memory 14, the terminal unit 11 transmits a search request to extract search results composed of candidate characters following the “FAR” and the number of candidates to the server unit 41 via the communication device 2.

If, after the search request to extract candidate characters following “FAR” and the number of candidates is transmitted to the server unit 41 and while the response to the search request from the server unit 41 is being delayed due to a communication delay, the user inputs additional characters “NINTOM” from the character input panel 1304, the terminal unit 11 transmits a search request to make a search based on the search character string “FARNINTOM” to the server unit 41 via the communication device 2.

Regardless of whether or not search results in response to the last search request made with the search character string “FARNINTOM” have been received, the candidate characters following the “FAR” and the number of candidates are subsequently received with delay response from the server unit 41 at the terminal unit 11, the candidate characters (M, W, . . . ) following the “FAR” and the number of candidates (10) are reflected on the character input panel 1304 shown in FIG. 2. At the same time, the received search results are stored in the cache memory 14 shown in FIG. 1.

The reason of processing above step is as follows. That is, the character string inputted by a user is “FARNINTOM”, whereas “N” following the characters “FAR” has not been included among the candidate characters (M, W, . . . ) following the “FAR”. So the inputted character string “FARNINTOM” on the display of the search character string 1302 is reverted to “FAR”. As a result, the display of the search character string 1302 changes to “FAR”.

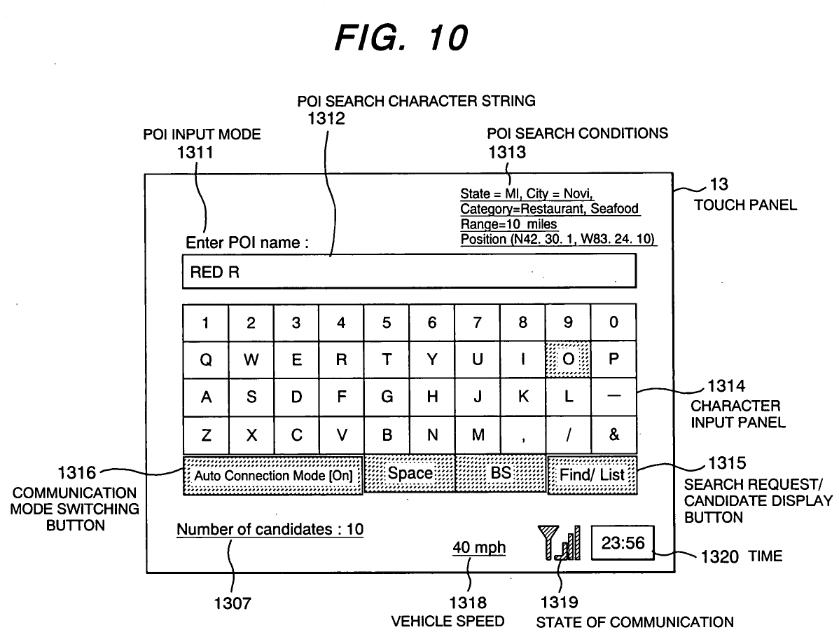

The foregoing description has been provided using examples of processing to search for a place name. FIG. 10 shows a POI (Point of Interest) search screen.

In FIG. 10, the “POI” represents information on a restaurant, a parking lot, a gas station or the like in an area where the communication-type navigation system is used.

The touch panel 13 used for a POI search has a display configuration as shown in FIG. 10. Namely, the touch panel 13 displays the following contents: a POI input mode 1311 indicating a search category (for example, restaurant name) to make a POI search; a POI search character string 1312 showing a search character string used in an address search; POI search conditions 1313 indicating an area category (state, county, or city) for a search; a character input panel 1314 used to input characters; a search request/candidate display button 1315 used to extract candidate addresses corresponding to the inputted POI search character string 1312; a communication mode switching button 1316; a number of candidates 1317 indicating the number of candidate characters for next input extracted as a result of making a search request; a current vehicle speed 1318, a current state of communication 1319 indicating the state of the communication device 2a with radio field intensity and other information using for example, an icon and a moving images; and a time 1320. The POI search conditions 1313 can specify a state and city as an area to be searched, latitude and longitude of the area, and a search area radius. The genre, classification, or field of the POI to be searched for can also be included in the POI search conditions 1313.

When a part of a character string to specify a destination is inputted from the on-vehicle terminal system 1, candidate characters for next input are downloaded from the server system 4 and the downloaded candidate characters are color-highlighted on the touch panel 13.

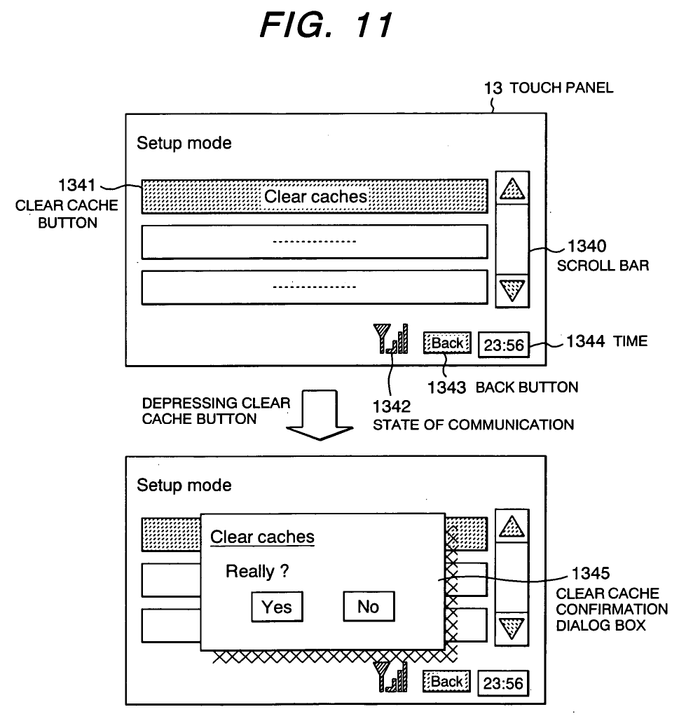

FIG. 11 shows an operation made on the touch panel 13 to erase the data stored in the cache memory 14. When the database stored in the server system is updated, the preceding data stored in the cache memory 14 may become invalid. Whether or not the database has been updated, however, cannot be known without communicating with the server system. Therefore, when the auto connection mode is off, there is fear of using data of the cache memory made invalid. The setup button 1310 is used to manually issue an instruction to clear the cache memory so as to prevent search results which have become invalid from being extracted from the cache memory.

When the setup button 1310 on the touch panel 13 shown in FIG. 2 is pressed, a setup mode screen as shown in FIG. 11 appears enabling various setup displays. Operating a scroll bar 1340 makes various buttons scroll up or down on the setup mode screen, thereby a clear cache button for erasing data of the cache memory appears on the screen.

In FIG. 11, reference numeral 1342 denotes a state of communication, 1343 denotes a “Back” button used to make the current setup mode screen revert to the previous screen, and 1344 denotes a time display.

When, in a state shown in FIG. 11, the clear cache button 1341 is pressed, a clear cache confirmation dialog box appears over the buttons displayed on the screen. The clear cache confirmation dialog box is titled “Clear caches” and includes a prompt message “Really?” urging the user to respond. If the user presses “Yes” in response, the data stored in the cache memory 14 is erased. If the user presses “No” in response, the data stored in the clear cache is not erased, and the screen reverts to the previous setup mode screen where various setup buttons appear.

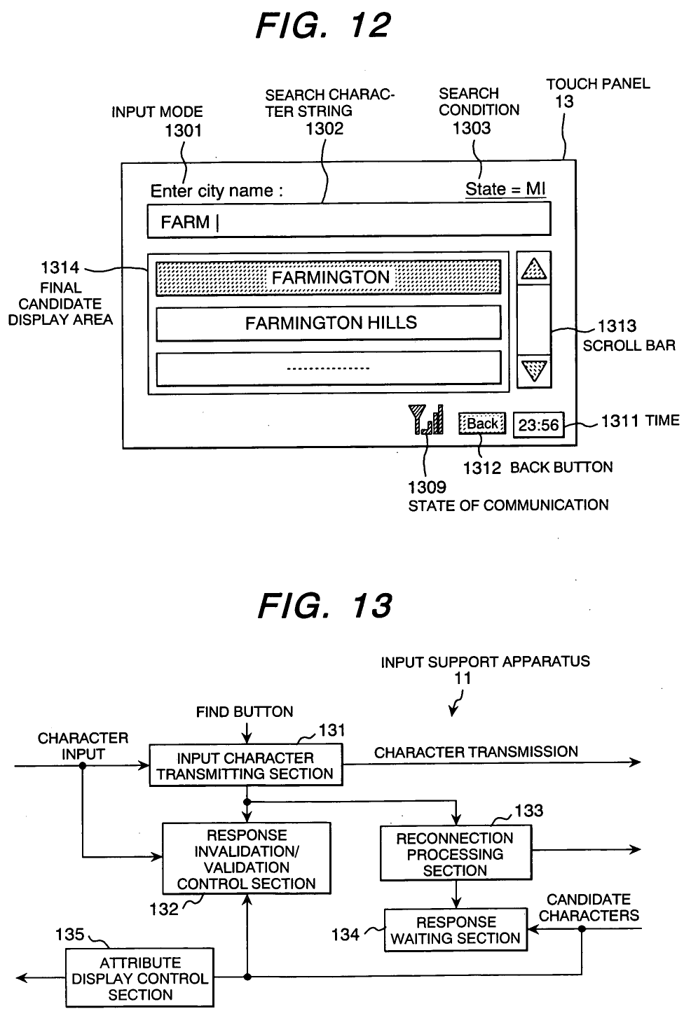

FIG. 12 shows an example of display showing candidates narrowed down in an address search. When, as in the present example, a search made with the input mode 1301, the search character string 1302, and the search conditions 1303 find two candidates “FARMINGTON” and “FARMINGTON HILLS”, they are displayed in a final candidate display area 1314 as shown in FIG. 12. When there are more final candidates than can be viewed at a time, they can be viewed by scrolling the screen using the scroll bar 1313. Such final candidates obtained through a narrowing-down process are stored in the cache memory 14.

### INDUSTRIAL APPLICABILITY

The present invention when applied to an apparatus for guiding a car can shorten communication time and quicken response time.

1. An input support method in a communication-type navigation system in which a navigation apparatus and a server system are connected via a communication network, the input support method comprising:
a first step of obtaining candidate characters for next input and the number of candidates pertaining to an input character string from the server system via the communication network, and storing them into a cache memory provided in the navigation apparatus;
a second step of, at least when an input character string is updated at the navigation apparatus, searching the cache memory for candidate characters following the updated input character string and the number of candidates pertaining to the updated input character string; and
a third step of, when the candidate characters following the updated input character string and the number of candidates pertaining to the updated character string have not been stored in the cache memory as yet, transmitting the updated input character string to the server system.

2. The input support method in a communication-type navigation system according to claim 1 further comprising:
a first step of obtaining candidate characters for next input and the number of candidates pertaining to an input character string from the server system via the communication network, and storing them into a cache memory provided in the navigation apparatus;
a fourth step of, when making the updated input character string, in place of taking the candidate characters following the updated input character string from the server system, taking a character by an input operation, and
a fifth step of correcting the updated input character string if necessary and showing it by display.

3. The input support method in a communication-type navigation system according to claim 1, further comprising a sixth step of, when a response of candidate characters following the updated input character string is not received as a response from the server system in a predetermined period of time, transmitting again a request to search for the candidate characters and the number of candidates based on the updated input character string.

4. The input support method in a communication-type navigation system according to claim 1, further comprising a seventh step of, when a response of the candidate characters following the updated input character string and the number of candidates pertaining to the updated input character string is belatedly received from the server system due to a communication delay, storing data of the belated candidate characters and the number of candidates into the cache memory.

5. The input support method in a communication-type navigation system according to claim 1, further comprising an eighth step of, when a character has been already input to the updated character string, correcting the input character based on the response of the candidate characters and the number of candidate from the server system.

6. The input support method in a communication-type navigation system according to claim 1, wherein the navigation apparatus makes an address search.

7. The input support method in a communication-type navigation system according to claim 1, wherein the navigation apparatus makes a POI search.
